(19) United States
(12) Patent Application Publication
(10) Pub. No.: US 2023/0233017 A1
(43) Pub. Date: Jul. 27, 2023

(54) Grease Spatter Containment Device

(71) Applicant: Teresa Burnett, Chesterfield, VA (US)

(72) Inventor: Teresa Burnett, Chesterfield, VA (US)

(21) Appl. No.: 17/582,878

(22) Filed: Jan. 24, 2022

(51) Int. Cl. A47J 36/06; A47J 36/20

(52) U.S. Cl. CPC A47J 36/06; A47J 36/20

(57) ABSTRACT

A grease spatter containment device for containing bacon grease spatter includes a lid, which is selectively engageable to a pan so that the lid covers an open top of the pan. The lid comprises a plurality of layers, with adjacently positioned layers being separated by a gap. A plurality of apertures is positioned in the plurality of layers so that apertures positioned in one of the adjacently positioned layers are offset from the apertures positioned in the other of the adjacently positioned layers. The lid thus contains grease spatter resulting from cooking of a food item, such as bacon, that is positioned upon an elevated grated cooking surface that is positioned in the pan.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to containment devices and more particularly pertains to a new containment device for containing bacon grease spatter. The present invention discloses a containment device comprising a perforated lid for a pan that contains grease spatter.

### (2) Description of Related Art Including Information Disclosed Under 37 CFR 1.97 and 1.98

The prior art relates to containment devices. Related prior art comprises a variety of pans having elements engaged to, or positionable upon, their bottoms for elevating food items from their bottoms. What is lacking in the prior art is a perforated lid for such pans that contains grease spatter.

### BRIEF SUMMARY OF THE INVENTION

An embodiment of the disclosure meets the needs presented above by generally comprising a lid, which is configured to be selectively engageable to a pan so that the lid covers an open top of the pan. The lid comprises a plurality of layers, with adjacently positioned layers being separated by a gap. A plurality of apertures is positioned in the plurality of layers so that apertures positioned in one of the adjacently positioned layers are offset from the apertures positioned in the other of the adjacently positioned layers. The lid thus is configured to contain grease spatter resulting from cooking of a food item, such as bacon, that is positioned upon an elevated grated cooking surface that is positioned in the pan.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric perspective view of a grease spatter containment device according to an embodiment of the disclosure.

FIG. 2 is a bottom isometric perspective view of an embodiment of the disclosure.

FIG. 3 is a top exploded view of an embodiment of the disclosure.

FIG. 4 is a side view of an embodiment of the disclosure.

FIG. 5 is an in-use view of an embodiment of the disclosure.

FIG. 6 is a top view of an embodiment of the disclosure.

FIG. 7 is a cross-sectional view of an embodiment of the disclosure.

### DETAILED DESCRIPTION OF THE INVENTION

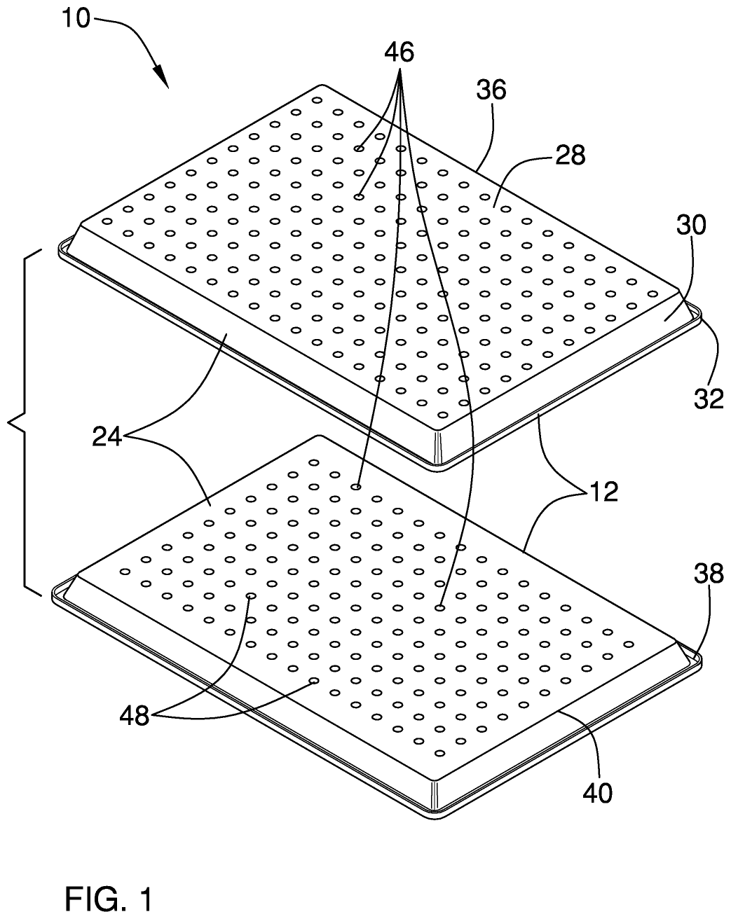

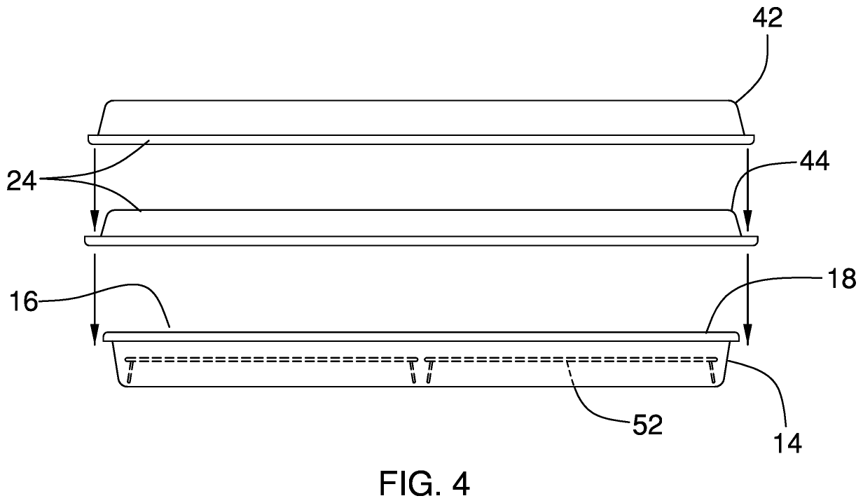

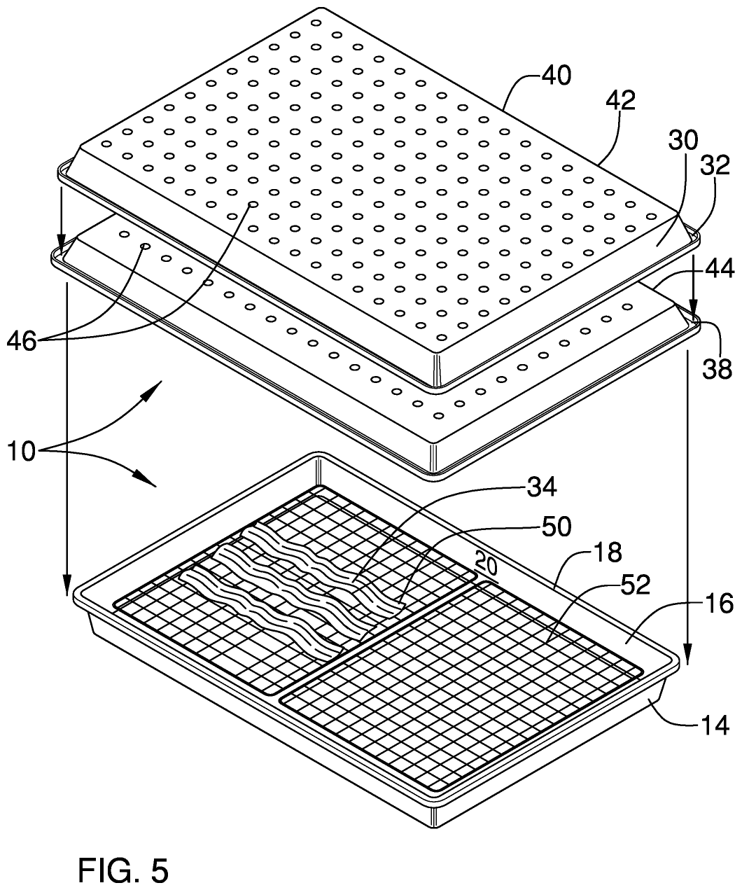

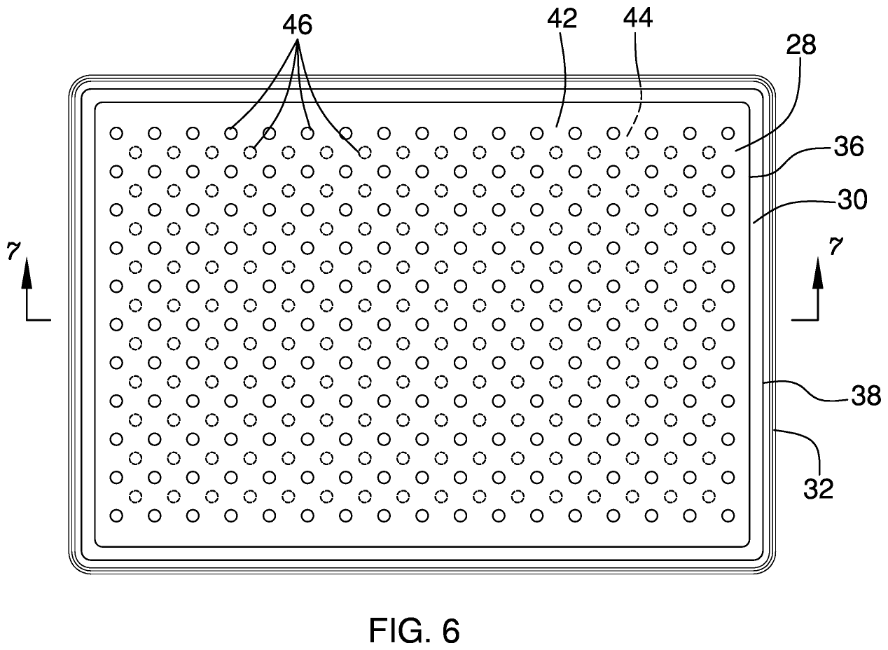

With reference now to the drawings, and in particular to FIGS. 1 through 7 thereof, a new containment device embodying the principles and concepts of an embodiment of the disclosure and generally designated by the reference numeral 10 will be described.

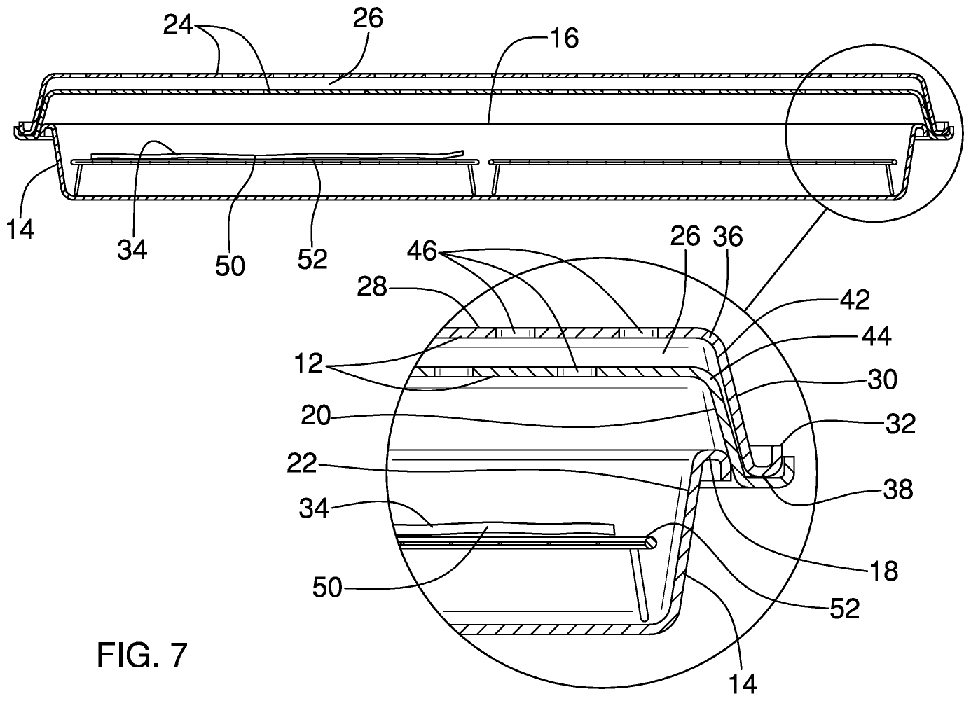

As best illustrated in FIGS. 1 through 7, the grease spatter containment device 10 generally comprises a lid 12, which is configured to be selectively engageable to a pan 14 so that the lid 12 covers an open top 16 of the pan 14. The lid 12 may be circumferentially larger than the pan 14. The lid 12 thus would be configured for partial insertion of a rim 18 of the pan 14 so that an inner surface 20 of the lid 12 frictionally engages the rim 18 of the pan 14, as shown in FIG. 7. The present invention also anticipates the lid 12 being circumferentially equivalent to the pan 14 and attachable by clamping means, or the like. The present invention further anticipates the lid 12 being circumferentially smaller than the pan 14 and thus partially insertable into the pan 14 so that the lid 12 frictionally engages an inner face 22 of the pan 14.

The lid 12 comprises a plurality of layers 24, with adjacently positioned layers 24 being separated by a gap 26. The plurality of layers 24 may comprise two layers 24, although the present invention also anticipates the plurality of layer 24 comprising three or more layers 24. The layers 24 are selectively mutually engageable and thus are configured to be separated to allow for cleaning of the lid 12.

Each layer 24 comprises a plate 28, a sidewall 30, and a lip 32. The plate 28 may be rectangular, which would be optimal for a lid 12 used on a pan 14 for cooking bacon 34. The present invention also anticipates the lid 12 be of alternative shapes, such as, but not limited to, circular, hexagonal, and the like. The sidewall 30 is engaged to and extends from a perimeter 36 of the plate 28. The sidewall 30 may extend transversely from the plate 28, although the present invention also anticipates the sidewall 30 extending perpendicularly from the plate 28. The lip 32 is engaged to and extends from the sidewall 30 so that the lip 32 and the sidewall 30 define a channel 38.

Each plate 28 has a respective circumference 40 so that the plurality of layers 24 comprises layers 24 having plates 28 of a variety of circumferences 40. The layers 24 thus are stackable with the lip 32 of an upper one 42 of the adjacently positioned layers 24 being nested in the channel 38 of a lower one 44 of the adjacently positioned layers 24, as shown in FIG. 7.

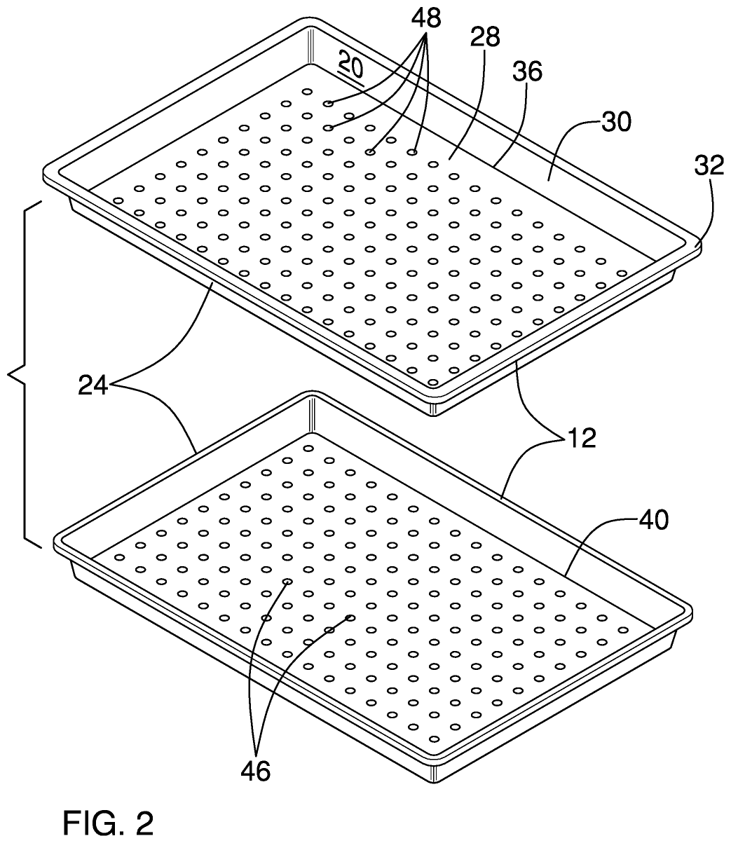

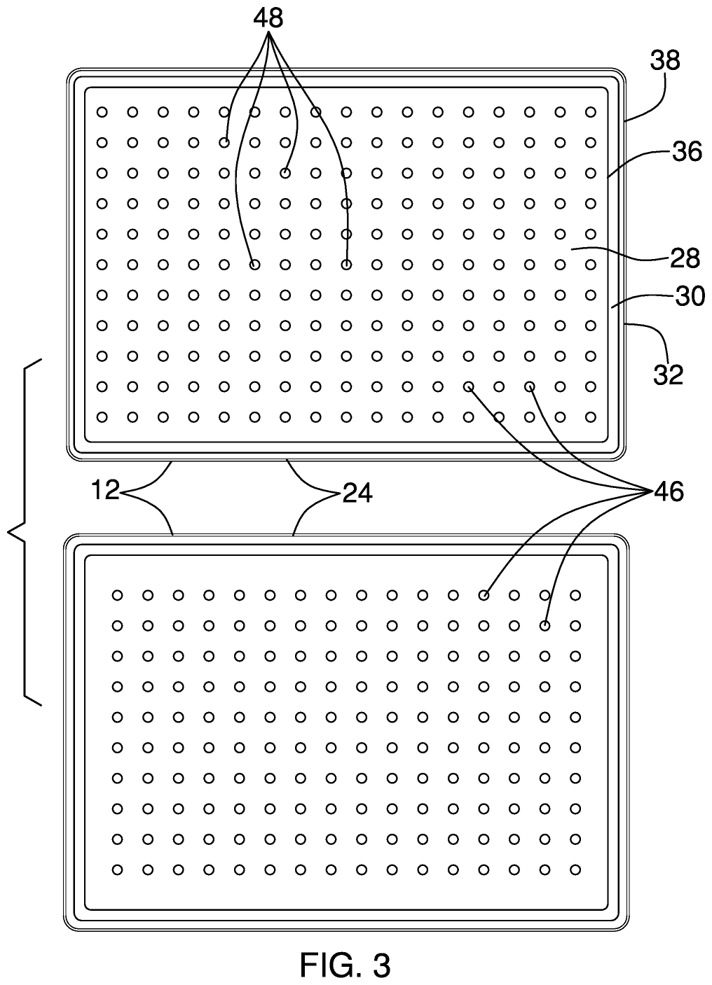

A plurality of apertures 46 is positioned in the plurality of layers 24 so that apertures 46 positioned in one of the adjacently positioned layers 24 are offset from the apertures 46 positioned in the other of the adjacently positioned layers 24. The plurality of apertures 46 are positioned in the plates 28. The apertures 46 which are positioned in each plate 28 may be positioned in a grid formation 48. Each aperture 46 may be circular, as shown in FIGS. 2 and 3. The present invention also anticipates the apertures 46 being alternatively shaped, such as rectangular, triangular, and the like. The lid 12 thus is configured to contain grease spatter resulting from cooking of a food item 50, such as the bacon 34, that is positioned upon an elevated grated cooking surface 52 that is positioned in the pan 14. The lid 12 also could be used to contain grease spatter resulting from cooking of a food item 50 positioned directly on the pan 14.

In use, the elevated grated cooking surface 52 is positioned in the pan 14 and the food item 50, such as the bacon 34, is positioned upon the elevated grated cooking surface 52. The lid 12 then is engaged to the pan 14 and the pan 14 is positioned in an oven to cook the food item 50. Grease spatter resulting from cooking of the food item 50 is contained by the lid 12. Upon completion of cooking, the layers 24 of the lid 12 can be separated and cleaned.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A grease spatter containment device comprising:
a lid configured to be selectively engageable to a pan, such that the lid covers an open top of the pan, the lid comprising a plurality of layers, with adjacently positioned layers being separated by a gap; and
a plurality of apertures positioned in the plurality of layers, such that apertures positioned in one of the adjacently positioned layers are offset from the apertures positioned in the other of the adjacently positioned layers, wherein the lid is configured for containing grease spatter resulting from cooking of a food item positioned upon an elevated grated cooking surface positioned in the pan.

2. The grease spatter containment device of claim 1, wherein the lid is circumferentially larger than the pan, wherein the lid is configured for partial insertion of a rim of the pan, such that an inner surface of the lid frictionally engages the rim of the pan.

3. The grease spatter containment device of claim 1, wherein the plurality of layers comprises two layers.

4. The grease spatter containment device of claim 1, wherein the layers are selectively mutually engageable, wherein the layers are configured for being separated for cleaning the lid.

5. The grease spatter containment device of claim 4, wherein each layer comprises:
a plate, the plurality of apertures being positioned in the plates;
a sidewall engaged to and extending from a perimeter of the plate; and
a lip engaged to and extending from the sidewall, such that the lip and the sidewall define a channel, each plate having a respective circumference, such that the plurality of layers comprises layers having plates of a variety of circumferences, such that the layers are stackable with the lip of an upper one of the adjacently positioned layers being nested in the channel of a lower one of the adjacently positioned layers.

6. The grease spatter containment device of claim 5, wherein the apertures positioned in each plate are positioned in a grid formation.

7. The grease spatter containment device of claim 5, wherein the plate is rectangular.

8. The grease spatter containment device of claim 5, wherein the sidewall extends transversely from the plate.

9. The grease spatter containment device of claim 1, wherein each aperture is circular.

10. A grease spatter containment system comprising:
a pan;
an elevated grated cooking surface positioned in the pan;
a food item positioned upon the elevated grated cooking surface;
a lid selectively engageable to the pan, such that the lid covers an open top of the pan, the lid comprising a plurality of layers, with adjacently positioned layers being separated by a gap; and
a plurality of apertures positioned in the plurality of layers, such that apertures positioned in one of the adjacently positioned layers are offset from the apertures positioned in the other of the adjacently positioned layers, such that the lid contains grease spatter resulting from cooking of the food item.

11. A grease spatter containment device comprising:
a lid configured to be selectively engageable to a pan, such that the lid covers an open top of the pan, the lid comprising a plurality of layers, with adjacently positioned layers being separated by a gap, the lid being circumferentially larger than the pan, wherein the lid is configured for partial insertion of a rim of the pan, such that an inner surface of the lid frictionally engages the rim of the pan, the plurality of layers comprising two layers, the layers being selectively mutually engageable, wherein the layers are configured for being separated for cleaning the lid, each layer comprising:
a plate, the plate being rectangular,
a sidewall engaged to and extending from a perimeter of the plate, the sidewall extending transversely from the plate, and
a lip engaged to and extending from the sidewall, such that the lip and the sidewall define a channel, each plate having a respective circumference, such that the plurality of layers comprises layers having plates of a variety of circumferences, such that the layers are stackable with the lip of an upper one of the adjacently positioned layers being nested in the channel of a lower one of the adjacently positioned layers; and
a plurality of apertures positioned in the plurality of layers, such that apertures positioned in one of the adjacently positioned layers are offset from the apertures positioned in the other of the adjacently positioned layers, wherein the lid is configured for containing grease spatter resulting from cooking of a food item positioned upon an elevated grated cooking surface positioned in the pan, each aperture being circular, the plurality of apertures being positioned in the plates, the apertures positioned in each plate being positioned in a grid formation.
